(19) United States
(12) Patent Application Publication
(10) Pub. No.: US 2006/0125284 A1
(43) Pub. Date: Jun. 15, 2006

(54) Motor vehicle body and motor vehicle

(76) Inventor: Rainer Kristl, Wernau (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/528,578

(22) PCT Filed: Aug. 29, 2003
(86) PCT No.: PCT/EP03/09608

§ 371 Date: Dec. 1, 2005

(30) Foreign Application Priority Data
Sep. 21, 2002 (DE) 102-43-898.6

(51) Int. Cl. B60J 5/00

(52) U.S. Cl. 296/146.11

(57) ABSTRACT

A motor vehicle body has at least two doors, which are arranged on one side of the vehicle, and a releasable body B-column, which is arranged between the two doors on the side of the vehicle in a position fixed on the body. A first of the two doors can be opened either by way of hinges along a first trajectory or by way of a pivoting clip along a second trajectory. The invention may be used, for example, for a variable door-opening system for easy loading with bulky goods.

### BACKGROUND AND SUMMARY OF THE INVENTION

This invention relates to a motor vehicle body having at least two doors, which are arranged on one side of the vehicle, and a releasable body B-column, which is arranged between the two doors on the side of the vehicle in a position fixed on the body. The invention also relates to a motor vehicle having a motor vehicle body according to the invention.

German patent specification 464 139 discloses a motor vehicle with a motor vehicle body having two doors, which are arranged on one side of the vehicle, and a releasable body B-column. The body B-column is arranged between the two doors on the side of the vehicle in a position fixed on the body. In order to be able to load a stretcher into the interior of the vehicle, the body B-column is fastened to the rear of the two doors. The B-column can be provided at the top and bottom with latches which are inserted into the roof frame and base frame of the vehicle body. The front door is fastened to an A-column and opens counter to the normal forward direction of travel. The rear of the two doors, to which the B-column is fastened, is fastened to a C-column and opens in the direction of travel.

U.S. Pat. No. 2,212,674 discloses a releasable body B-column. The B-column is attached in a vehicle floor by means of a hook and is fastened to the roof frame by means of a latching lever.

German laid-open specification DE 38 10 762 A1 discloses a motor vehicle body, in which a B-column is integrated into a rear door opening counter to the direction of travel. The B-column integrated into the rear door includes locking devices, for example bolts, which can interact with a roof frame and a floor frame.

An object of the invention is to provide a flexible motor vehicle body which, on the one hand, provides protection for the vehicle occupants and, on the other hand, is to be easily loaded even with bulky articles.

According to the invention, a motor vehicle body having at least two doors, which are arranged on one side of the vehicle, and a releasable body B-column, which is arranged between the two doors on the side of the vehicle in a position fixed on the body, is provided. A first of the two doors can be opened either by means of first articulation means along a first trajectory or by means of second articulation means along a second trajectory.

The opening of the doors is thereby designed in a flexible manner, and the first trajectory can be provided, for example, for a normal opening counter to the forward direction of travel. This avoids, in the driving mode, the known disadvantages of doors opening in the direction of travel. The second trajectory can be designed for a maximum possible opening of the door in order, by removal of the B-column, to be able to load bulky goods. For example, the first trajectory predetermines a conventional pivoting of the door and the second trajectory can bring about a pivoting or else displacement, if appropriate in the manner of a parallelogram and together with the B-column.

According to one feature of the invention, the first articulation means for the pivotable articulation of the first door are provided on the B-column.

This achieves a normal opening of the door counter to the direction of travel and, with regard to a conventional, modern vehicle, a change of the opening process during normal operation is not required.

In this case, the B-column stiffens the motor vehicle body, so that, firstly, the lack of structural rigidity and sealing problems of vehicles without a B-column are avoided and, secondly, impact protection is provided and easy fastening of the seatbelt to the B-column is possible.

According to another feature of the invention, the second articulation means for the pivotable articulation of the first door are provided on at least one point of the body that is different from the B-column.

The second articulation means for the alternative, second trajectory for opening the door with the effect of easy loading of bulky articles can be provided, for example, in the rear door frame region or else on the roof frame. The B-column may be, for example, removed or pivoted together with the first door. For example, multi-joint hinges could be used as the second articulation means to provide more freedom in the selection of the trajectory.

According to another feature of the invention, the first articulation means are designed as at least one door hinge which connects the first door to the B-column.

In this manner, with regard to a conventional vehicle, a change to the door itself is not required. This is of importance in particular for the retrospective conversion of a vehicle, for example of vehicles for the disabled.

According to another feature of the invention, the second articulation means are designed as at least one pivoting clip and means are provided in order either to connect the first door pivotably to the body structure by means of the pivoting clip or to open it up in the region of the pivoting clip.

A pivoting clip makes it possible for the second trajectory of the door to be configured in a freer manner, and nevertheless a stable, simple construction can be realized.

According to another feature of the invention, the pivoting clip is connected pivotably to the body structure and, by means of a door lock, can optionally act on the first door.

This also ensures that, with regard to a conventional vehicle, only slight changes are required, since the optional connection of the pivoting clip to the body structure takes place via a door lock which is present in any case. For example, the pivoting clip is latched to the door by means of the door lock, and, during opening, the door is held via the door lock and further supporting surfaces on the pivoting clip and door.

According to another feature of the invention, the door lock of the first door can act on a locking eye which is connected pivotably to the body structure by means of the lockable pivoting clip.

This measure also reduces the required changes with regard to conventional vehicles, since the door is connected to the pivoting clip by means of the locking eye, which is present in any case. During normal operation, the pivoting clip or the locking eye can be locked directly to the door frame.

According to another feature of the invention, the first door is connected pivotably to the B-column in the region of a front door edge and can optionally be connected pivotably to the body structure in the region of an opposite, rear door edge.

This achieves a conventional door opening for maximum safety of the occupants during normal operation and, in the case of pivoting about the rear door edge, a maximum door opening for easy loading can be achieved. An opening angle of the first, rear door and of the second, front door is then expediently at least 90°.

According to another feature of the invention, means are provided for the controlled connection of the second articulation means to the first door or the body structure and for the subsequent release of the B-column from the body structure.

For example, if required by a driver, a controlled, consecutive unlocking of the B-column from the remaining body structure, the locking of the door lock to the locking eye and the opening up of the pivoting clip can take place.

According to another feature of the invention, the B-column can be connected, on the one hand, to a roof frame and, on the other hand, to a sill by means of tension rods, compression rods and/or intercepting hooks.

This achieves a stable, simple construction, for example in a manner similar to a lock for a convertible roof.

The problem on which the invention is based is also solved by a motor vehicle having a motor vehicle body according to the invention.

Further features and advantages of the invention emerge from the claims and the description below of a preferred embodiment in conjunction with the drawings.

### BRIEF DESCRIPTION OF THE DRAWINGS

FIGS. 1A, 1B and 1C show perspective views of a section of a motor vehicle body according to the invention in the case of normal door opening,

FIGS. 2A and 2B show sectional views of the motor vehicle body of FIGS. 1A to 1C in the case of normal door opening,

FIGS. 3A, 3B and 3C show views of the motor vehicle body of FIGS. 1A, 1B and 1C during the opening of the doors to provide a maximum door opening,

FIGS. 4A and 4B show sectional views of the motor vehicle body of FIGS. 1A, 1B and 1C during the opening of the doors to provide a maximum door opening,

FIG. 5 shows a schematic illustration of a releasable body B-column according to the invention, and

FIG. 6 shows a schematic illustration of a control device for the motor vehicle body according to the invention.

### DETAILED DESCRIPTION OF THE INVENTION

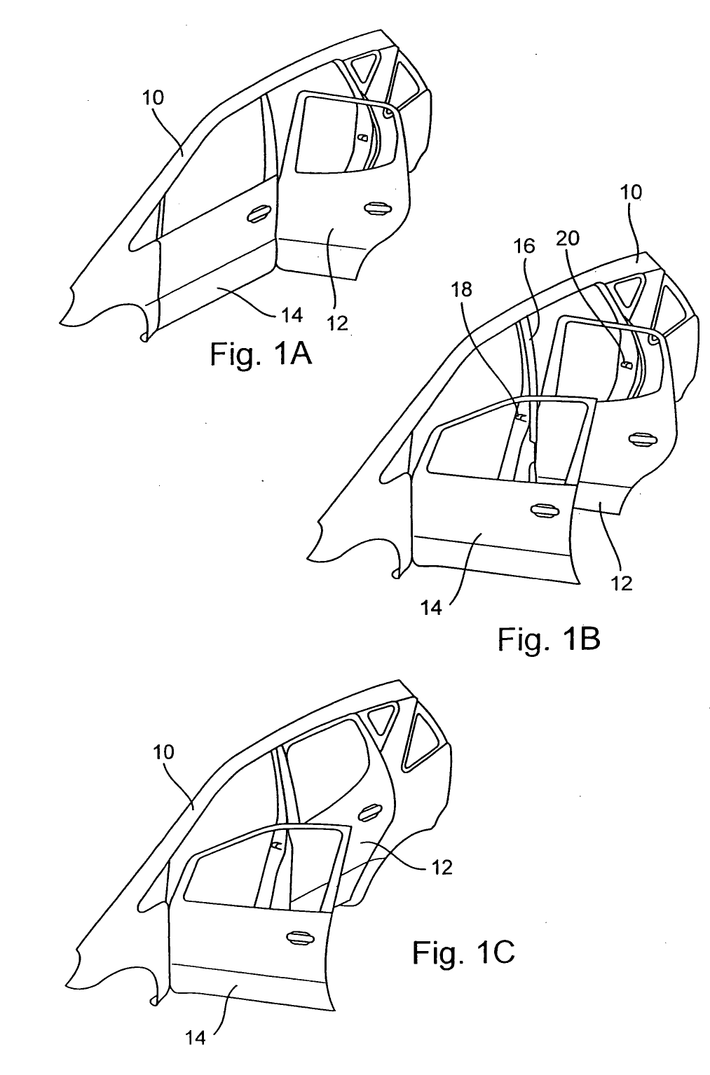

The illustrations of FIGS. 1A, 1B and 1C show a side part 10 of a motor vehicle body according to the invention having a first, rear door 12, a second, front door 14 and a releasable B-column 16. The front door 14 is fastened to the side part 10 in the region of an A-column by means of conventional door hinges and a door lock of the front door 14 engages in a locking eye 18 on the B-column 16. The rear door 12 is fastened to the B-column 16 in a conventional manner per se by means of two door hinges and consequently opens, like the front door 14, counter to the forward direction of travel. In the driving mode, such an opening counter to the direction of travel has, for example, the advantage that the doors 12, 14 can be closed by the relative wind and consequently cannot spring open unexpectedly. The door lock of the rear door 12 engages in a locking eye 20 which is arranged in the region of a C-column of the side part 10.

As can be gathered from FIGS. 1A, 1B and 1C, an opening of the doors in the normal operation illustrated takes place in an entirely conventional manner, and an opening of the front door 14 and of the rear door 15 is possible independently of each other. By means of the B-column 16, the roof frame of the side part 10 is supported against the sill region, and the motor vehicle body consequently has a rigidity which is not reduced in comparison to conventional bodies and provides protection in the event of an impact. For example, a seatbelt may also be fastened to the B-column 16.

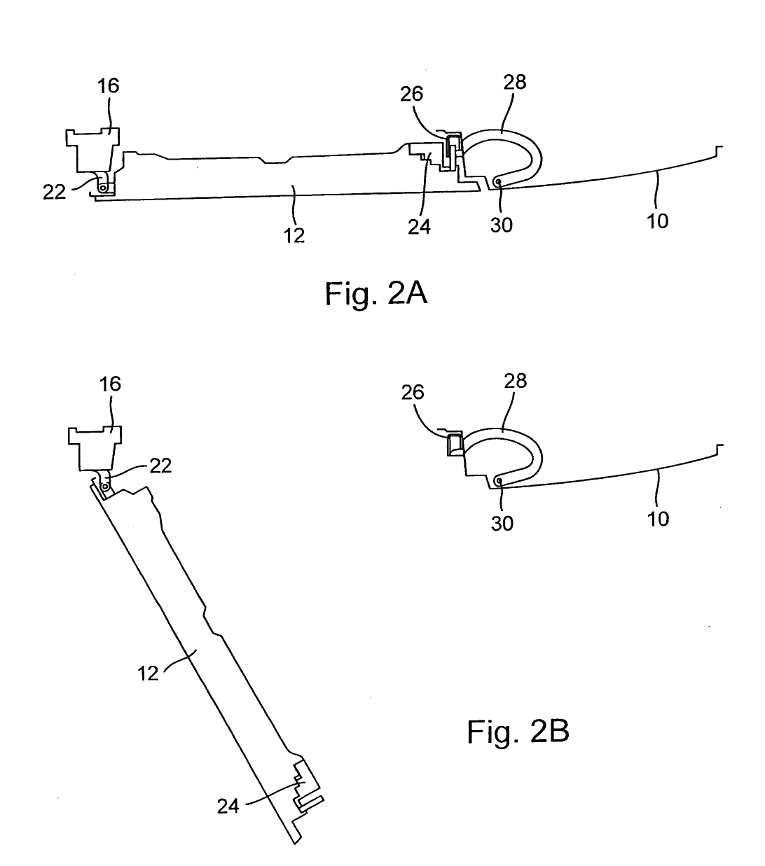

In the sectional views of FIGS. 2A and 2B, the B-column 16 and the rear door 12 and a rear wing of the side part 10 can be seen in each case. As has already been described, the rear door 12 is articulated on the B-column 16 by means of conventional door hinges 22. A door lock 24 of the rear door 12 acts in a known manner on a locking eye 26 which is arranged on the rear edge of the door frame in the side part 10. The locking eye 26 is connected to a pivoting clip 28 which, for its part, is connected pivotably to the side part 10 at an articulation point 30. In the case of the normal door opening which is illustrated in FIGS. 2A and 2B, the locking eye 26 and/or the pivoting clip 28 is locked, so that a relative movement between the rear edge of the door frame of the side part 10 and the locking eye 26 cannot occur. In consequence, in the closed position according to FIG. 2A, the door 12 is held securely on the side part 10. Since, in the normal operation illustrated, the B-column 16 is also connected securely to the side part 10 and, for example, is locked thereto, in the event of a vehicle impact the motor vehicle body according to the invention behaves in the same manner as a conventional motor vehicle body without a releasable B-column.

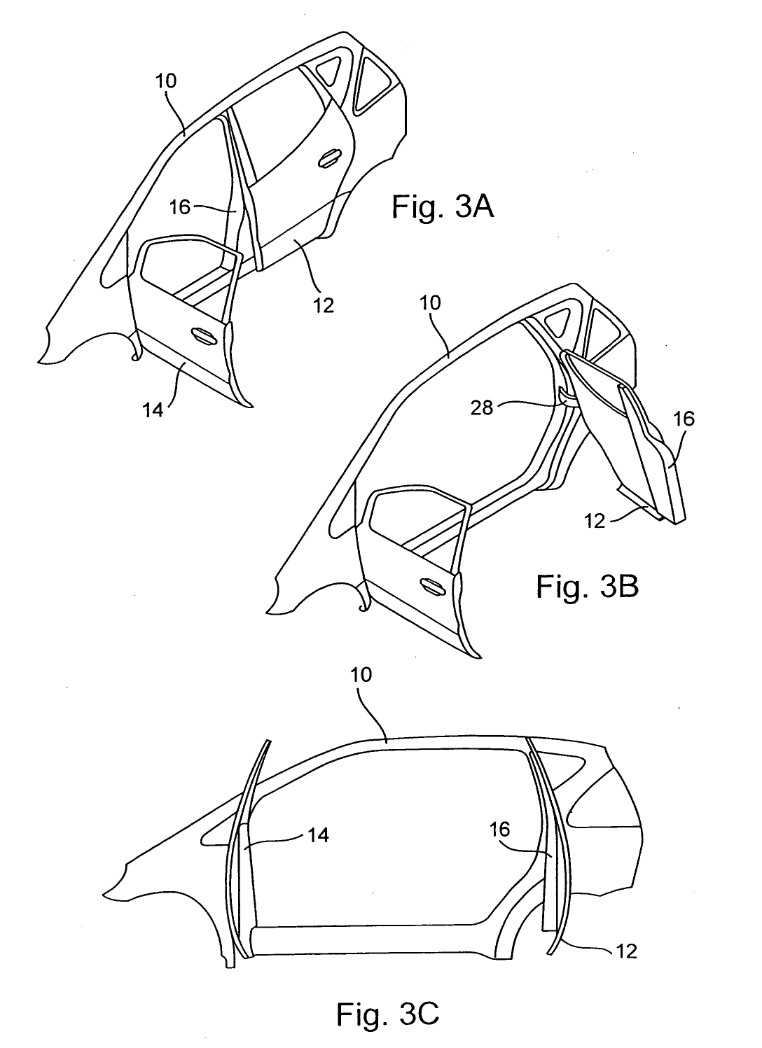

The views of FIGS. 3A, 3B and 3C show the side part 10 with the doors 12 and 14 and the B-column 16 of the motor vehicle body of FIGS. 1A, 1B and 1C in the case of an opening of the doors 12 and 14 to provide a maximum door opening.

As can be seen in FIG. 3A, first of all the front door 14 is opened to an opening angle of approximately 90°. Then, provided that the door lock of the rear door 12 is locked to the locking eye, the means of locking the B-column 16 to the sill and to the roof frame of the side part 10 are opened up. The means of locking the locking eye and/or the pivoting clip to the side part 10 can then be opened up, so that, as can be seen in FIG. 3B, the rear door 12 together with the B-column 16 can be pivoted about the C-column of the side part 10 by means of the pivoting clip 28. In this case, the B-column 16 is held on the door 12 by means of the conventional door hinges.

As can be gathered from the side view of FIG. 3C, the rear door 12 can also be opened by an angle of 90° by means of the pivoting clip 28, so that the entire, maximum door opening is available in the side part 10 for loading bulky articles or, for example, removing the seats without the B-column 16 being able to obstruct a loading process.

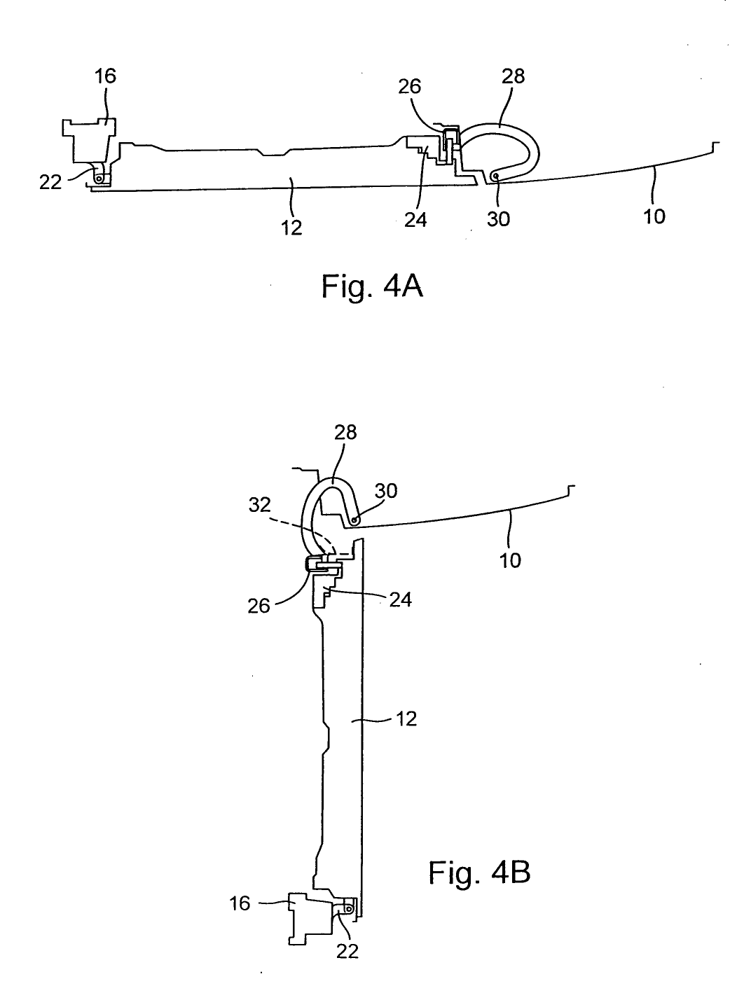

Analogously to the sectional views of FIGS. 2A and 2B, the sectional views of FIGS. 4A and 4B show the B-column 16, the rear door 12 and the rear wing of the side part 10 in the case of an opening of the rear door 12 to provide a maximum door opening counter to the normal forward direction of travel of the motor vehicle.

The sectional view of FIG. 4A shows the closed state of the rear door 12, which has already been illustrated in FIG. 2A. Starting from the state of FIG. 4A, first of all the front door has to be opened, then the means of locking the B-column 16 to the side part 10 can be released and a means of locking the locking eye 26 and/or the pivoting clip 28 to the side part 10 is released. In this case, the means of locking the B-column 16 must only be released when the door lock 24 of the rear door 12 has latched into the locking eye 26.

The rear door 12 can then be pivoted about the articulation point 30 of the pivoting clip 28 to an opening angle of approximately 90°. As has already been described, the B-column 16 is held in the process on the door 12 by means of the conventional door hinges 22. In addition to the fastening of the rear door 12 to the pivoting clip 28 by means of the door lock 24 and the locking eye 26, further supporting elements 32 (merely indicated by dashed lines in FIG. 4A), can be provided in order to hold the rear door 12 securely on the pivoting clip 28 during opening.

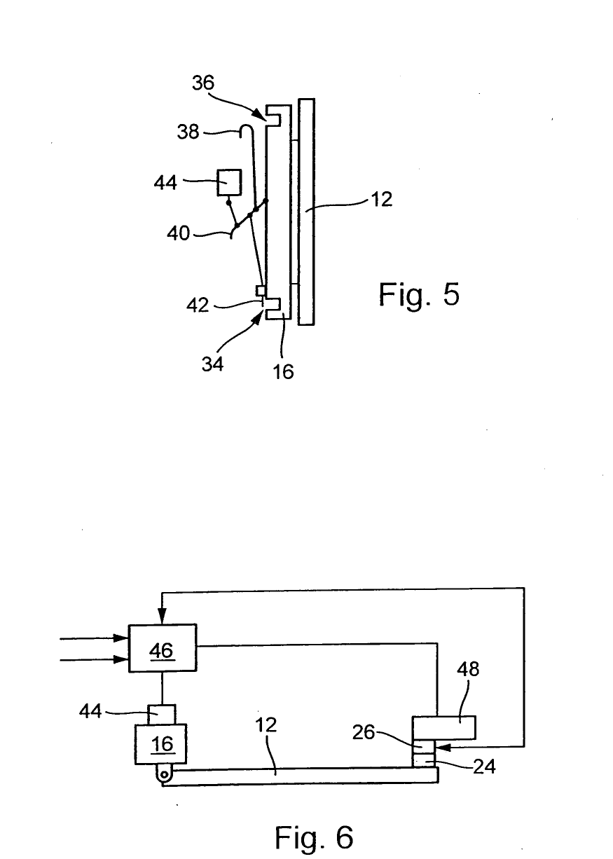

The schematic illustration of FIG. 5 illustrates the B-column 16 and the rear door 12. The B-column 16 has recesses 34 and 36 which can be pushed onto matching projections on the side part of the motor vehicle body and ensure that the B-column 16 is held securely on the side part. In order to lock the B-column 16 to the side part, an intercepting hook 38 is provided in the region of the upper recess 36 and can engage in a matching opening on the side part 10. The intercepting hook 38 is connected to a lever 40 by means of a tension rod. Actuation of the lever 40 makes it possible, in a similar manner to the locking of a convertible roof, for the intercepting hook 38 and therefore the B-column 16 to be braced against the side part. A latch 42, which is likewise connected to the lever 40 by means of an actuating rod, is provided in the region of the lower recess 34 of the B-column 16. When the lever 40 is actuated, the intercepting hook 38 is therefore firstly pulled downward in FIG. 5 and at the same time the latch 42 is pushed downward. The B-column 16 can therefore be securely anchored on the side part by means of the latch 42 and the intercepting hook 38. The actuation of the lever 40 can either take place manually or by means of an electrically activatable device, for example a lifting magnet 44.

The schematic illustration of FIG. 6 illustrates a control system in order to trigger in a controlled manner the unlocking and locking processes to be undertaken for the alternative trajectories of the rear door 12. A central control unit 46 contains, as input signals, a command to prepare the opening of the rear door 12 to provide a maximum door opening. Such a command can be initiated, for example, by a driver. Furthermore, the control unit 46 receives input signals concerning the driving state of the vehicle. For example, the unlocking of the B-column 16 can only take place when the vehicle is stationary and the ignition is switched off. In addition, the control unit 46 receives an input signal concerning whether the door lock 24 of the rear door 12 is securely latched to the locking eye 26 on the side part.

If the required boundary conditions for the opening of the rear door 12 to provide a maximum door opening are provided, the control unit 46 first of all sends a command to the lifting magnet 44 which then, as has been illustrated schematically in FIG. 5, releases the means of locking the B-column 16 to the side part of the motor vehicle body. At the same time, the control unit 46 can release the means of locking the pivoting clip 28 (illustrated in FIGS. 4A and 4B) and/or the locking eye 26 to the motor vehicle body. After the means of locking the B-column 16 and the pivoting clip and/or the locking eye 26 have been released, the rear door 12 can then be opened rearward about the pivoting clip, as illustrated in FIG. 3B. The control unit 46 expediently blocks the locking of the door lock 24 to the locking eye 26 as soon as the means of locking the B-column to the side part of the motor vehicle body have been released. This prevents the rear door 12 from inadvertently being released from the locking eye 26 and the pivoting clip by actuation of a door handle.

After the door 12 has been closed again and the B-column 16 is arranged at the designated position between the roof frame and sill of the side part, the control unit 46, upon an appropriate request command, ensures the locking of the B-column 16 to the side part and the locking of the pivoting clip and/or of the locking eye 26 to the door frame of the side part. The blocking of the door lock 24 can thereupon be cancelled and the rear door 12 can be opened again in normal, conventional manner. At the same time, for example, the ignition of the motor vehicle can be opened up again for the driving mode.

1-9. (canceled)

10. A motor vehicle body comprising:
first and second doors arranged on one side of the vehicle body,
a body B-column arranged between the doors on the one side of the vehicle body in a position fixed on the body,
first articulation means for pivotable articulation of the first door provided on the B-column, and
second articulation means for pivotable articulation of the first door provided on at least one point of the body that is different from the B-column,
wherein it is possible for the first of the two doors to be opened either by first articulation means along a first trajectory or by second articulation means along a second trajectory, and
wherein the body B-column is releasable and, in a released state, is pivotable together with the first door.

11. The motor vehicle body as claimed in claim 10, wherein the first articulation means is designed as at least one door hinge which connects the first door to the B-column.

12. The motor vehicle body as claimed in claim 10, wherein the second articulation means is designed as at least one pivoting clip, and wherein means are provided in order either to connect the first door pivotably to structure of the body by way of the pivoting clip or to open the first door up in the region of the pivoting clip.

13. The motor vehicle body as claimed in claim 12, wherein the pivoting clip is connected pivotably to the structure of the body and, by way of a door lock, can optionally act on the first door.

14. The motor vehicle body as claimed in claim 13, wherein the door lock of the first door can act on a locking eye which is connected pivotably to the structure of the body by the pivoting clip, and wherein the pivoting clip is lockable.

15. The motor vehicle body as claimed in claim 10, wherein the first door is connected pivotably to the B-column in a region of a front door edge and can optionally be connected pivotably to the body structure in a region of an opposite, rear door edge.

16. The motor vehicle body as claimed in claim 10, wherein means are provided for controlled connection of the second articulation means to the first door or the structure of the body and for subsequent release of the B-column from the structure of the body.

17. The motor vehicle body as claimed in claim 10, wherein the B-column can be connected to a roof frame and to a sill by tension rods, compression rods, intercepting hooks, tension rods and compression rods, tension rods and intercepting hooks, or tension rods, compression rods, and intercepting hooks.

18. A motor vehicle comprising a motor vehicle body according to claim 10.

19. The motor vehicle body as claimed in claim 11, wherein the second articulation means is designed as at least one pivoting clip, and wherein means are provided in order either to connect the first door pivotably to structure of the body by way of the pivoting clip or to open the first door up in the region of the pivoting clip.

20. The motor vehicle body as claimed in claim 19, wherein the pivoting clip is connected pivotably to the structure of the body and, by way of a door lock, can optionally act on the first door.

21. The motor vehicle body as claimed in claim 13, wherein the door lock of the first door can act on a locking eye which is connected pivotably to the structure of the body by the pivoting clip, and wherein the pivoting clip is lockable.

22. The motor vehicle body as claimed in claim 11, wherein the first door is connected pivotably to the B-column in a region of a front door edge and can optionally be connected pivotably to the body structure in a region of an opposite, rear door edge.

23. The motor vehicle body as claimed in claim 11, wherein means are provided for controlled connection of the second articulation means to the first door or the structure of the body and for subsequent release of the B-column from the structure of the body.

24. The motor vehicle body as claimed in claim 11, wherein the B-column can be connected to a roof frame and to a sill by tension rods, compression rods, intercepting hooks, tension rods and compression rods, tension rods and intercepting hooks, or tension rods, compression rods, and intercepting hooks.

25. A motor vehicle comprising a motor vehicle body according to claim 11.

26. The motor vehicle body as claimed in claim 12, wherein the first door is connected pivotably to the B-column in a region of a front door edge and can optionally be connected pivotably to the body structure in a region of an opposite, rear door edge.

27. The motor vehicle body as claimed in claim 12, wherein means are provided for controlled connection of the second articulation means to the first door or the structure of the body and for subsequent release of the B-column from the structure of the body.

28. The motor vehicle body as claimed in claim 12, wherein the B-column can be connected to a roof frame and to a sill by tension rods, compression rods, intercepting hooks, tension rods and compression rods, tension rods and intercepting hooks, or tension rods, compression rods, and intercepting hooks.

29. A motor vehicle comprising a motor vehicle body according to claim 12.
